(19) United States
(12) Patent Application Publication
(10) Pub. No.: US 2011/0299018 A1
(43) Pub. Date: Dec. 8, 2011

(54) LIQUID CRYSTAL DISPLAY DEVICE AND MANUFACTURING METHOD THEREFOR

(76) Inventor: Masatoshi Itoh, Osaka-shi (JP)

(21) Appl. No.: 13/202,622

(22) PCT Filed: Feb. 22, 2010
(86) PCT No.: PCT/JP2010/001131

§ 371 Date: Aug. 22, 2011

(30) Foreign Application Priority Data
Feb. 25, 2009 (JP) 2009-043187
Jun. 10, 2009 (JP) 2009-139537

(51) Int. Cl. G02F 1/1337; H01J 9/24

(52) U.S. Cl. 349/123; 445/24

(57) ABSTRACT

A method for producing a liquid crystal display device (100) according to the present invention includes the steps of preparing a liquid crystal cell (110) including a rear substrate (120) having an alignment film (126), a front substrate (140) having an alignment film (146), and a mixture (C) interposed between the alignment film (126) of the rear substrate (120) and the alignment film (146) of the front substrate (140), the mixture (C) containing a liquid crystal compound and a photopolymerizable compound dissolved in the liquid crystal compound at a concentration of 0.22 wt. % or higher and 0.28 wt. % or less; and polymerizing the photopolymerizable compound contained in the mixture of the liquid crystal cell (110) to form alignment sustaining layers (130, 150) respectively on the alignment films (126, 146) of the rear substrate (120) and the front substrate (140).

### TECHNICAL FIELD

The present invention relates to a liquid crystal display device and a method for producing the same.

### BACKGROUND ART

Liquid crystal display devices are used as, for example, small display devices such as display sections of mobile phones in addition to display sections of large-screen TVs. TN (Twisted Nematic) mode liquid crystal display devices often used conventionally have a relatively narrow viewing angle. Recently, wide viewing angle liquid crystal display devices of an IPS (In-Plane-Switching) mode, a VA (Vertical Alignment) mode and the like have been produced. Among such wide viewing angle modes, the VA mode can realize a high contrast ratio and so is adopted for many liquid crystal display devices. Liquid crystal display devices include alignment films for regulating alignment directions of liquid crystal molecules in the vicinity thereof. In a VA mode liquid crystal display device, the alignment films align the liquid crystal molecules approximately vertically to main surfaces of the alignment films.

As one type of VA mode, an MVA (Multi-domain Vertical Alignment) mode, by which a plurality of liquid crystal domains are formed in one pixel area, is known. In an MVA mode liquid crystal display device, on at least one of a pair of substrates which face each other with a vertical alignment type liquid crystal layer interposed therebetween, an alignment anchoring structure is provided on the liquid crystal layer side. The alignment anchoring structure is formed of, for example, linear slits (openings) or ribs (projecting structures) provided in or on an electrode. Owing to the alignment anchoring structure, an alignment anchoring force is supplied from one side or both of two sides of the liquid crystal layer, and so a plurality of liquid crystal domains (typically, four liquid crystal domains) having different alignment directions are formed. In this manner, it is attempted to improve the viewing angle characteristics.

As another type of VA mode, a CPA (Continuous Pinwheel Alignment) mode is also known. In a general CPA mode liquid crystal display device, pixel electrodes having a highly symmetrical shape are provided, and also projections are provided on a counter electrode in correspondence with the centers of the liquid crystal domains. Such projections are referred to also as “rivets”. When a voltage is applied, liquid crystal molecules are radially aligned while being inclined in accordance with an oblique electric field formed by the counter electrode and the pixel electrodes of a highly symmetrical shape. By an alignment anchoring force provided by inclined side surfaces of the rivets, the inclined alignment of the liquid crystal molecules is stabilized. In this manner, the liquid crystal molecules in each pixel are aligned radially, in an attempt to improve the viewing angle characteristics.

In a general VA mode, liquid crystal molecules are aligned in a direction normal to main surfaces of the alignment films in the absence of a voltage. When a voltage is applied to the liquid crystal layer, the liquid crystal molecules are aligned in prescribed directions. Meanwhile, it has been studied to use the Polymer Sustained Alignment Technology (hereinafter, referred to as the “PSA technology”) in order to improve the response speed of a liquid crystal display device (see Patent Documents 1 and 2). According to the PSA technology, a pretilt direction of the liquid crystal molecules is controlled by polymerizing a polymerizable compound in the state where a voltage is applied to a liquid crystal layer containing a small amount of the polymerizable compound (e.g., a photopolymerizable monomer) mixed therein. As a result, the liquid crystal molecules are pretilted in the absence of a voltage such that the liquid crystal molecules are inclined with respect to the direction normal to the main surfaces of the alignment films.

Patent Document 1 describes a liquid crystal display device of an MVA mode in which slits or ribs are provided as the alignment anchoring structures. The liquid crystal display device described in Patent Document includes linear slits and/or ribs. When a voltage is applied, liquid crystal molecules are aligned such that an azimuthal angle component of the liquid crystal molecules is perpendicular to the slits or ribs. When the liquid crystal molecules are irradiated with ultraviolet light in this state, a polymer is formed and the alignment state of the liquid crystal molecules is sustained (stored). Then, even after the voltage is stopped being applied, the liquid crystal molecules are still inclined at the pretilt azimuth with respect to the direction normal to the main surfaces of the alignment films.

Patent Document 2 describes a liquid crystal display device having electrodes in a pattern of tiny stripes. When a voltage is applied to the liquid crystal layer, the liquid crystal molecules are aligned parallel to a longitudinal direction of the stripes. This is of a contrast to the liquid crystal display device described in Patent Document 1, in which the liquid crystal molecules are aligned such that the azimuthal angle component thereof is perpendicular to the slits or ribs. In the liquid crystal display device described in Patent Document 2, a plurality of slits are provided, and so the disturbance of the alignment is suppressed. The liquid crystal display device is irradiated with ultraviolet light in this state to sustain (store) the alignment state of the liquid crystal molecules. Even after the voltage is stopped being applied, the liquid crystal molecules are still inclined at the pretilt azimuth with respect to the direction normal to the main surfaces of the alignment films. In this manner, the liquid crystal molecules are pretilted in the absence of a voltage, in an attempt to improve the response speed.

### CITATION LIST

### Patent Literature

Patent Document 1: Japanese Laid-Open Patent Publication No. 2002-357830
Patent Document 2: Japanese Laid-Open Patent Publication No. 2003-149647

### SUMMARY OF INVENTION

### Technical Problem

The present inventor found that a liquid crystal display device produced using the PSA technology occasionally generate light spots and one reason for this is abnormal growth of the polymer.

The present invention made in light of the above-described problem has an object of providing a liquid crystal display device in which the generation of light spots is suppressed and a method for producing such a liquid crystal display device.

### Solution To Problem

A method for producing a liquid crystal display device according to the present invention includes the steps of preparing a liquid crystal cell including a rear substrate having an alignment film, a front substrate having an alignment film, and a mixture interposed between the alignment film of the rear substrate and the alignment film of the front substrate, the mixture containing a liquid crystal compound and a photopolymerizable compound dissolved in the liquid crystal compound at a concentration of 0.22 wt. % or higher and 0.28 wt. % or less; and polymerizing the photopolymerizable compound contained in the mixture of the liquid crystal cell to form alignment sustaining layers respectively on the alignment films of the rear substrate and the front substrate.

In an embodiment, the step of preparing the liquid crystal cell includes the step of bringing the rear substrate and the front substrate together using a photocurable resin or a thermosetting resin.

In an embodiment, in the step of preparing the liquid crystal cell, the mixture further contains a chiral agent.

A liquid crystal display device according to the present invention is produced by the above-described method.

### Advantageous Effects of Invention

According to the present invention, a liquid crystal display device in which the generation of light spots is suppressed can be provided.

### BRIEF DESCRIPTION OF DRAWINGS

FIG. 1(a) is a schematic view of a liquid crystal display device in Embodiment 1 according to the present invention, and FIG. 1(b) is a schematic view showing a pixel electrode and alignment directions of liquid crystal molecules in the liquid crystal display device.

FIG. 2 shows an SEM image of an alignment sustaining layer of the liquid crystal display device in Embodiment 1.

FIG. 3(a) shows a schematic view of a liquid crystal display device in Comparative Example 1, FIG. 3(b) shows a schematic view of a liquid crystal display device in Comparative Example 2, and FIG. 3(c) shows a schematic view of the liquid crystal display device in the above embodiment according to the present invention.

FIGS. 4(a) and 4(b) are schematic views showing a method for producing the liquid crystal display device shown in FIG. 1.

FIGS. 5(a) through 5(e) are schematic views showing a more specific method for producing the liquid crystal display device shown in FIG. 1.

FIG. 6 is a schematic view of a liquid crystal display device in Embodiment 2 according to the present invention.

### DESCRIPTION OF EMBODIMENTS

Hereinafter, liquid crystal display devices in embodiments according to the present invention will be described with reference to the drawings. The present invention is not limited to the following embodiments.

### Embodiment 1

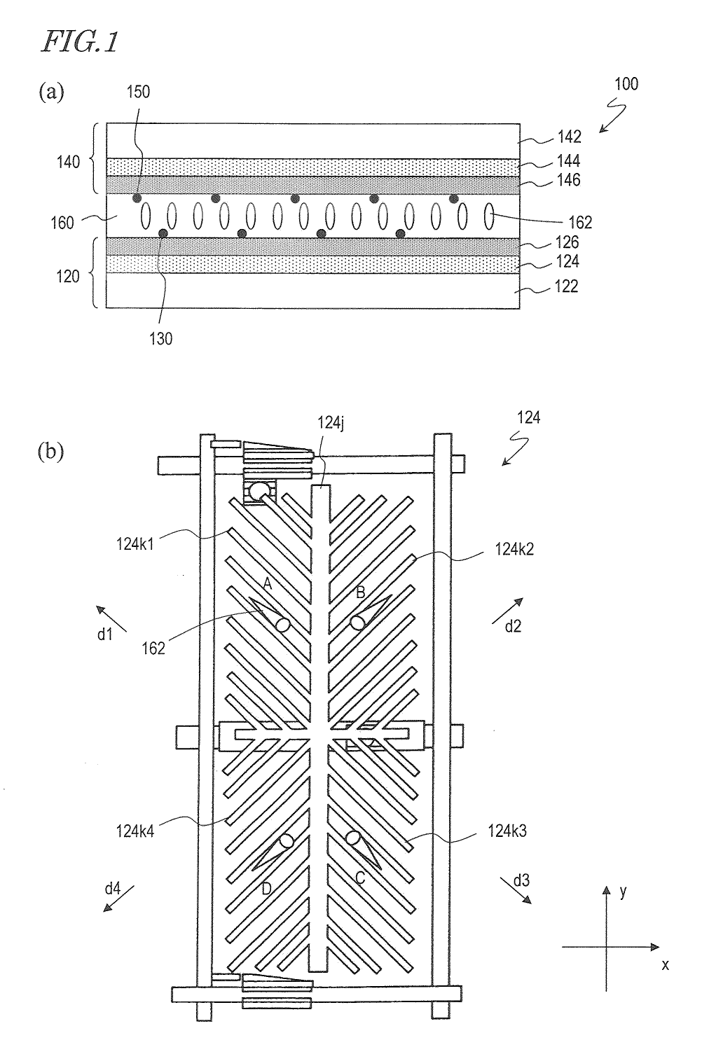

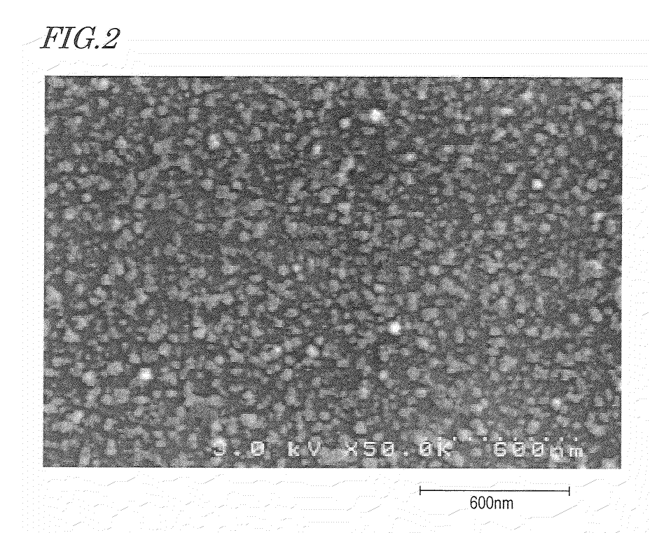

Hereinafter, a Liquid Crystal Display Device in an embodiment according to the present invention will be described with reference to FIG. 1 and FIG. 2.

FIG. 1(a) is a schematic view of a liquid crystal display device 100 in this embodiment. The liquid crystal display device 100 includes a rear substrate 120, a front substrate 140, and a liquid crystal layer 160. The rear substrate 120 includes a transparent insulating plate 122, pixel electrodes 124, and an alignment film 126. The front substrate 140 includes an insulating plate 142, a counter electrode 144, and an alignment film 146. The liquid crystal layer 160 is interposed between the rear substrate 120 and the front substrate 140. The liquid crystal display device 100 may include a backlight when necessary.

The liquid crystal display device 100 includes pixels arranged in a matrix having a plurality of rows and a plurality of columns. The rear substrate 120 includes switching elements (e.g., thin film transistors (TFTs); not shown). At least one such switching element is provided for each of the pixels. In this specification, the term “pixel” refers to a minimum unit which represents a particular gray scale level in display. In color display, a pixel corresponds to a unit representing, for example, the gradation of each of R, G and B, and is also referred to as a “dot”. A combination of an R pixel, a G pixel and a B pixel forms one color display pixel. The term “pixel area” refers to an area of the liquid crystal display device 100 which corresponds to the “pixel” for display. The rear substrate 120 is also referred to as the “active matrix substrate”, and the front substrate 140 is also referred to as the “counter substrate”. In the case where the liquid crystal display device 100 is a color liquid crystal display device, the front substrate 140 often includes a color filter. In such a case, the front substrate 140 is also referred to as the “color filter substrate”.

Although not shown, the rear substrate 120 and the front substrate 140 each include a polarizing plate. Thus, the two polarizing plates are located to face each other while having the liquid crystal layer 160 therebetween. Transmission axes (polarization axes) of the two polarizing plates are located so as to be perpendicular to each other. One is located to be along a horizontal direction (row direction), and the other is located to be along a vertical direction (column direction). When necessary, a wave plate may also be provided between each of the polarizing plates and the insulating plate 122 or 142.

The liquid crystal layer 160 contains a nematic liquid crystal compound (liquid crystal molecules 162) having a negative dielectric anisotropy. The liquid crystal layer 160 is of a vertical alignment type, and the liquid crystal molecules 162 are aligned at approximately 90° with respect to surfaces of the alignment films 126 and 146. When necessary, the liquid crystal layer 160 may contain a chiral agent incorporated therein. The liquid crystal layer 160, in combination with the polarizing plates located in crossed Nicols, provides display in a normally black mode.

As shown in FIG. 1(b), in the liquid crystal display device 100, the pixel electrodes 124 each include a cruciform trunk electrode 124j and linear electrodes 124k1 through 124k4 extending from the trunk electrode 124j in four different directions d1 through d4. Such a structure of the pixel electrode is referred to as a “fishbone structure”. The trunk electrode 124j extends in x and y directions. For example, in the pixel electrode 124, the trunk electrode 124j has a width of 3 μm. The linear electrodes 124k1, 124k2, 124k3 and 124k4 each have a width of 3 μm and are located at an interval of 3 μm. Assuming that the horizontal direction (left-right direction) of the display screen (the plane of the sheet of FIG. 1(b)) is the reference on which the direction of azimuthal angle is set and the counterclockwise direction is the positive direction (assuming that the display screen is the face of a clock, the direction of 3 o'clock is 0° in azimuthal angle and the counterclockwise direction is the positive direction), the directions d1 through d4 are directed at 135°, 45°, 315°, and 225°, respectively.

When a voltage is applied to the liquid crystal layer 160 of the liquid crystal display device 100, the liquid crystal molecules 162 are aligned parallel to the directions in which the corresponding linear electrodes 124k1 through 124k4 extend as shown in FIG. 1(b). The liquid crystal layer 160 is of a vertical alignment type, and includes a liquid crystal domain A formed by the linear electrodes 124k1, a liquid crystal domain B formed by the linear electrodes 124k2, a liquid crystal domain C formed by the linear electrodes 124k3, and a liquid crystal domain D formed by the linear electrodes 124k4. When no voltage is applied to the liquid crystal layer 160 or when the voltage applied thereto is relatively low, the liquid crystal molecules 162 are aligned vertically to main surfaces of the alignment films (not shown) except for the liquid crystal molecules 162 in the vicinity of the pixel electrode 124. By contrast, when a prescribed level of voltage is applied to the liquid crystal layer 160, the liquid crystal molecules 162 are aligned in the directions d1 through d4 in which the linear electrodes 124k1, 124k2, 124k3 and 124k4 extend.

In this specification, the alignment direction of the liquid crystal molecules at the center of each of the liquid crystal domains A through D is referred to as the “reference alignment direction”. Of the reference alignment direction, an azimuth angle component of a direction from the rear side to the front side along the longer axis of the liquid crystal molecules (namely, the azimuth angle component of the liquid crystal molecules projected on the main surfaces of the alignment films) is referred to as the “reference alignment azimuth”. The reference alignment azimuth characterizes a corresponding liquid crystal domain and dominantly influences the viewing angle characteristics of the respective liquid crystal domain. Where the horizontal direction (left-right direction) of the display screen (the plane of the sheet of FIG. 1(b)) is the reference direction on which the direction of azimuth angle is set and the counterclockwise direction is the positive direction, the reference alignment azimuths of the four liquid crystal domains A through D are set such that the difference between two random azimuths out of these four azimuths is generally equal to an integral multiple of 90°. Specifically, the reference alignment azimuths of the liquid crystal domains A, B, C and D are 315°, 225°, 135° and 45°, respectively. In this manner, the liquid crystal molecules 162 are aligned in four different directions, and owing to this, the viewing angle characteristics are improved.

The pixel electrode 124 shown in FIG. 1(b) has a fishbone structure, but the liquid crystal display device 100 may be of, for example, an ASV, a CPA or a PVA (Patterned Vertical Alignment) mode, and the pixel electrode 124 may include a unit electrode of a highly symmetrical shape (for example, a generally square shape).

In the liquid crystal display device 100 in this embodiment, an alignment sustaining layer 130 is provided on the alignment film 126 on the liquid crystal layer 160 side. The alignment sustaining layer 130 contains a polymerization product formed by polymerization of a photopolymerizable compound. An alignment sustaining layer 150 is provided on the alignment film 146 on the liquid crystal layer 160 side. The alignment sustaining layer 150 contains a polymerization product formed by polymerization of a photopolymerizable compound. For example, the alignment sustaining layer 130 is formed of the same material as the alignment sustaining layer 150. In FIG. 1(a), the liquid crystal molecules 162 are shown to be aligned parallel to the direction normal to the main surfaces of the alignment films 126 and 146, but the alignment of the liquid crystal molecules 162 is sustained in a direction slightly inclined with respect to the direction normal to the main surfaces of the alignment films 126 and 146 by the alignment sustaining layers 130 and 150. As can been seen from this, the alignment directions of the liquid crystal molecules 162 are regulated by the alignment films 126 and 146 and the alignment sustaining layers 130 and 150. The alignment sustaining layers 130 and 150 are respectively provided on the alignment films 126 and 146 in a pattern of islands, and the surface of each of the alignment films 126 and 146 may be partially in contact with the liquid crystal layer 160. Once the liquid crystal molecules 162, aligned in accordance with the electric field formed in the liquid crystal layer 160, are fixed by the polymerization product, the alignment is sustained even in the absence of a voltage. After the alignment sustaining layers 130 and 150 are formed on the alignment films 126 and 146, the alignment sustaining layers 130 and 150 regulate the pretilt directions of the liquid crystal molecules.

With reference to FIG. 2, an example of the above-described alignment sustaining layers 130 and 150 will be described. The SEM image shown in FIG. 2 is a result of an observation of a surface of the alignment sustaining layer. Specifically, the liquid crystal display device 100 was disassembled, the liquid crystal material was removed, and then a surface of the alignment sustaining layer of the resultant surface was washed with a solvent and observed by an SEM. As can be seen from FIG. 2, the alignment sustaining layer contains particles of a polymerization product having a particle size of 50 nm or less. The polymerization product occasionally grows to have a particle size of 1 μm to 5 μm.

A photopolymerizable compound is soluble in a liquid crystal compound, and a mixture of a photopolymerizable compound and a liquid crystal compound is uses as a liquid crystal material. In the liquid crystal cell, the liquid crystal material is enclosed by the rear substrate 120, the front substrate 140 and a sealant, and the alignment sustaining layers 130 and 150 are formed by polymerizing the photopolymerizable compound contained in the liquid crystal material.

In this example, as the photopolymerizable compound, a polymerizable monomer having at least one ring structure or condensed ring structure and two functional groups directly bonded to the ring structure or condensed ring structure is used. For example, the monomer is selected from those expressed by the following general formula (1).

P¹-A¹-(Z¹-A²)ₙ-P² (1)

In general formula (1), P¹ and P² are functional groups, and are independently an acrylate, methacrylate, vinyl, vinyloxy, or epoxy group. A¹ and A² are ring structures, and independently represent a 1-4-phenylene group or a naphthalene-2,6-diyl group. Z¹ is a —COO— or —OCO— group or a single bond, and n is 0, 1 or 2.

In general formula (1), P¹ and P² are preferably an acrylate group, Z¹ is preferably a single bond, and n is preferably 0 or 1. Preferable monomers are, for example, compounds expressed by the following formulas.

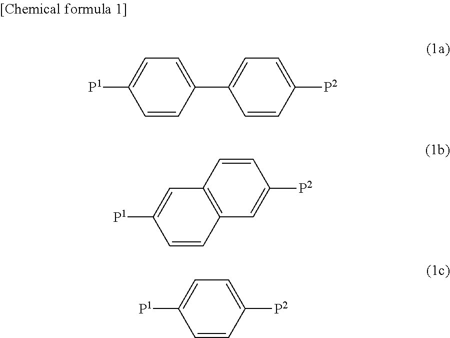

In structural formulas (1a) through (1c), P¹ and P² are as described above regarding general formula (1). Especially preferably, P¹ and P² are each an acrylate group. Among the above-identified compounds, the compounds expressed by structural formulas (1a) and (1b) are highly preferable, and the compounds expressed by structural formula (1a) are especially preferable.

Although, to be precise, being varied in accordance with the temperature, when a limit amount of photopolymerizable monomer is dissolved in a liquid crystal compound in a temperature range used generally and practically, the concentration of the photopolymerizable monomer to the liquid crystal material is 0.4 to 0.5 wt. %. Even if a larger amount of photopolymerizable monomer is incorporated, the photopolymerizable monomer is not dissolved (dispersed) in the liquid crystal compound. The present inventor found the following: when a liquid crystal material obtained by dissolving a photopolymerizable monomer in a liquid crystal compound is dipped in vacuum, or when such a liquid crystal material is dripped to the front substrate or the rear substrate and the substrates are brought together, the liquid crystal material flows between the front substrate and the rear substrate; at this point, the concentration of the photopolymerizable monomer itself and/or the concentration of impurities taken into the liquid crystal material is occasionally non-uniform; and when the photopolymerizable monomer is polymerized in such a state, the polymer grows non-uniformly and as a result, light spots are generated.

In the liquid crystal display device 100 in this embodiment, the concentration of the photopolymerizable compound to the liquid crystal material is 0.22 wt. % or higher and 0.28. wt. % or less, and preferably is 0.25 wt. %. As described later in more detail, since the concentration of the photopolymerizable compound is appropriately set as described above, the response speed is improved and also the generation of the light spots is suppressed.

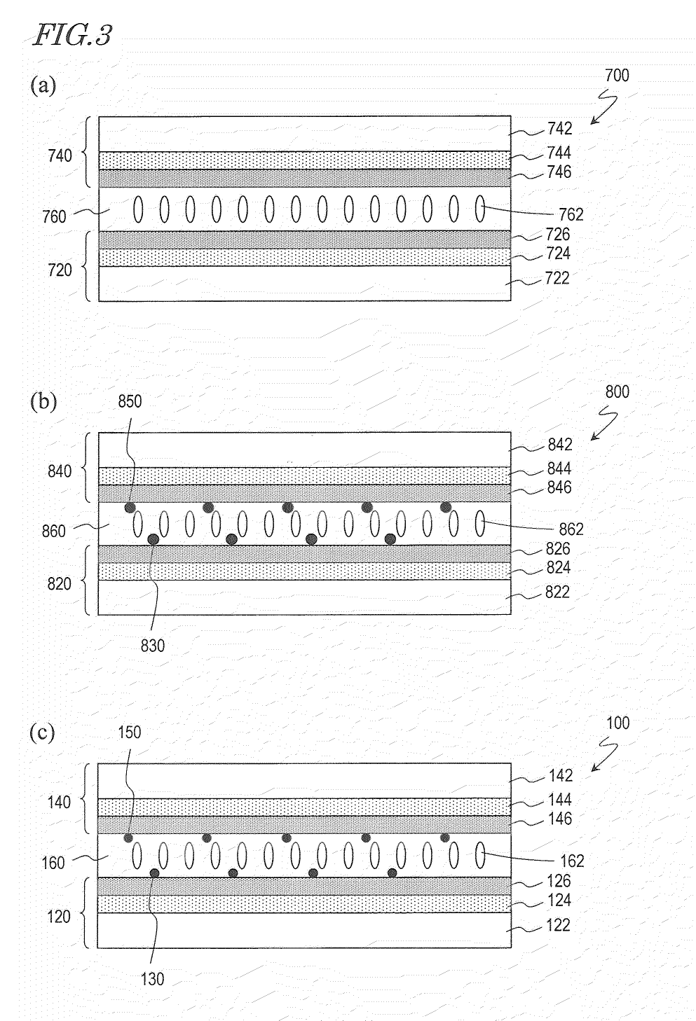

Hereinafter, with reference to FIG. 3, advantages of the liquid crystal display device 100 in this embodiment will be described as compared with liquid crystal display devices in Comparative Examples 1 and 2. FIG. 3(a) shows a schematic view of a liquid crystal display device 700 in Comparative Example 1, and FIG. 3(b) shows a schematic view of a liquid crystal display device 800 in Comparative Example 2. FIG. 3(c) shows a schematic view of the liquid crystal display device 100 in this embodiment.

In the liquid crystal display device 700 in Comparative Example 1, the liquid crystal layer contains no photopolymerizable monomer, and so the liquid crystal display device 700 includes no alignment sustaining layer. The liquid crystal display device 800 in Comparative Example 2 uses a liquid crystal material containing a photopolymerizable monomer at a concentration of 0.30 wt. %, and includes alignment sustaining layers 830 and 850. By contrast, the liquid crystal display device 100 uses a liquid crystal material containing a photopolymerizable monomer at a concentration of 0.22 wt. % or higher and 0.28 wt. % or less, and includes the alignment sustaining layers 130 and 150.

Comparing the liquid crystal display device 100 in this embodiment and the liquid crystal display device 700 in Comparative Example 1, the response speed of the liquid crystal display device 700 in Comparative Example 1 is lower. By contrast, the liquid crystal display device 100 in this embodiment has an improved response speed owing to the alignment sustaining layers 130 and 150. The liquid crystal display device 800 in Comparative Example 2 also has an improved response speed owing to the alignment sustaining layers 830 and 850, like the liquid crystal display device 100.

However, in the liquid crystal display device 800 in Comparative Example 2, light spots are occasionally generated. As a result of analyzing the liquid crystal display device 800 in Comparative Example 2, it was found that in the alignment sustaining layers 830 and 850 of the liquid crystal display device 800 in Comparative Example 2, the polymerization product has a relatively large particle size. It is considered that such alignment sustaining layers 830 and 850 act equivalently to the so-called structure bodies, and regulate the alignment of liquid crystal molecules 862 in addition to sustaining the alignment of the liquid crystal molecules 862; and as a result, the light spots are generated. By contrast, in the alignment sustaining layers 130 and 150 of the liquid crystal display device 100 in this embodiment, the polymerization product has a relatively small particle size, and so the generation of the light spots is suppressed. As described above, in the case where a photopolymerizable monomer is incorporated into the liquid crystal material, when the concentration of the photopolymerizable monomer to the liquid crystal material is high, light spots are generated. For this reason, it is preferable that the concentration of the photopolymerizable monomer in the liquid crystal material is not excessively high.

In the liquid crystal display device 700 in Comparative Example 1, the liquid crystal material contains no photopolymerizable monomer. Even in the case where the liquid crystal material contains a photopolymerizable monomer, when the concentration of the monomer to the liquid crystal material is low, the response speed is low like in the liquid crystal display device 700 in Comparative Example 1. In the case where the monomer concentration to the liquid crystal material is low, when one image is displayed for a long time and then another image (e.g., an image having the same gray scale level in the entire screen) is displayed, such an image occasionally appears to have a luminance of a gray scale level different from the gray scale level to be displayed, due to the previous image. Namely, ghosting occurs occasionally. From this viewpoint, it is preferable that the concentration of the photopolymerizable monomer in the liquid crystal material is not excessively low. In light of the above-mentioned points, for the liquid crystal display device 100 in this embodiment, the concentration of the photopolymerizable monomer to the liquid crystal material is set to 0.22. wt. % or higher and 0.28 wt. % or less. A photopolymerizable monomer of an amount corresponding to 0.22. wt. % or higher and 0.28 wt. % or less is soluble in a liquid crystal compound.

Hereinafter, with reference to Table 1, characteristics of liquid crystal panels having different monomer concentrations will be described. Table 1 shows the number of light spots per liquid crystal panel, and measurement results in an initial test, a ghosting test and an impact test when the monomer concentration was varied to 0.20 wt. %, 0.22 wt. %, 0.25 wt. %, 0.28 wt. %, 0.30 wt. % and 0.40 wt. %. The initial test, the ghosting test and the impact test were performed on a plurality of liquid crystal panels which were different in structure and condition, for example, different in pixel structure (having only transmissive regions, having a multi-gap structure including transmissive regions and reflective regions of different liquid crystal layer thicknesses), pixel size (VGA class at the smallest, QVGA class as the largest), electrode shape, electrode structure (specifically, rib structure, slit structure, fishbone structure), panel size (about 2 inches at the smallest, about 10 inches at the largest), etc.

The number of light spots was measured using 3-inch VGA-class liquid crystal display devices which were of a CPA mode, had a slit structure, included only transmissive regions and were of a high precision type with a small pixel pitch. In Table 1, in the sections of the initial test, the ghosting test and the impact test, “X” indicates that most of the types of liquid crystal display devices did not fulfill the acceptability standard, and “◯” indicates that most of the types of liquid crystal display devices fulfilled the acceptability standard. “Δ” indicates that some of the types of liquid crystal display devices did not fulfill the acceptability standard. The liquid crystal display devices which are of a CPA mode, have a slit structure and include only transmissive regions tend to fulfill the acceptability standard more easily than the other types of liquid crystal display devices. However, when being changed partially (e.g., when the pixel size or electrode shape is changed, when the electrode size is relatively fine, when the panel size is relatively large, or when a multi-gap structure is adopted), such a type of liquid crystal display devices occasionally do not fulfill the acceptability standard.

TABLE 1

| | Monomer concentration | | | | | |
|---|---|---|---|---|---|---|
| | 0.20 wt. % | 0.22 wt. % | 0.25 wt. % | 0.28 wt. % | 0.30 wt. % | 0.40 wt. % |
| No. of light | 0 | 0 | 0 | 0 | 20-30 | 50 or |
| spots/panel | | | | | | more |
| Initial test | X | ◯~Δ | ◯~Δ | ◯~Δ | ◯ | ◯ |
| Ghosting test | X | ◯ | ◯ | ◯ | ◯ | ◯ |
| Impact test | X | ◯ | ◯ | ◯ | ◯ | ◯ |

When the monomer concentration is 0.20 wt. %, 0.22 wt. %, 0.25 wt. % and 0.28 wt. %, no light spot is generated. By contrast, when the monomer concentration is 0.30 wt. % or higher, light spots are generated. As the monomer concentration is higher, the number of light spots per liquid crystal panel increases. From the viewpoint of suppressing the light spots, the monomer concentration needs to be 0.28 wt. % at the maximum. Especially preferably, the monomer concentration is 0.25 wt. % or less.

In the initial test, before the liquid crystal panel is operated for a long time, the display of the liquid crystal panel is checked in the state where a voltage is applied to the liquid crystal layer. Generally, when the monomer concentration is low, the amount of polymer in the alignment sustaining layers tends to be small. When the amount of polymer is excessively small, the alignment anchoring force is occasionally decreased or the pretilt angle provided to the liquid crystal molecules is occasionally reduced. Specifically, when the electric field is disturbed due to the structure bodies in the pixel when a voltage is applied, the liquid crystal molecules are aligned under an influence of the disturbance. As a result, the alignment uniformity of the liquid crystal molecules in each pixel is lost and so an alignment failure occurs.

In this example, the initial test is performed as follows. The liquid crystal panel is operated at a high temperature (e.g., 70° C.), room temperature (e.g., 20° C.) and a low temperature (e.g., −10° C.), and the display of the liquid crystal panel is checked visually and by a microscope. When the monomer concentration to the liquid crystal material is 0.20 wt. %, the alignment anchoring force provided by the alignment sustaining layers is insufficient in a part of the display area, and an alignment failure occurs. Specifically, liquid crystal domains, which are different from the liquid crystal domains to be formed, are formed in addition to the liquid crystal domain to be formed. For example, in the case where the pixel electrode has a fishbone structure, such different liquid crystal domains, starting mainly from the branching points in the electrode, are formed on the electrode. In the case where the liquid crystal display device is of a CPA mode or an ASV mode, alignment centers are formed at positions different from the positions which are to be the alignment centers, for example, the structure bodies or the slits. As a result, the liquid crystal molecules are not aligned while being inclined in a uniform state of axial symmetry in the pixel. In such a case, the display appears to be coarse. By contrast, when the monomer concentration is 0.22 wt. %, 0.25 wt. % and 0.28 wt. %, such an alignment failure does not occur almost at all. When the monomer concentration is 0.30 wt. % or higher, such an alignment failure does not occur.

In the ghosting test, it is checked whether ghosting occurs or not. Generally in the case where no polymer is formed, when one image (pattern) is displayed for a long time and then switched to another image, the previous image (pattern) appears to remain. This is called “ghosting”. Ghosting is suppressed by forming a polymer through polymerization of a photopolymerizable monomer. However, when the monomer concentration is decreased and so the amount of the polymer to be formed is reduced, the state of the resultant polymer (shape and adhering force) is changed by the difference in the level of the applied voltage (pattern difference). As a result, the pretilt angle is changed, or ion components in the liquid crystal layer are more likely to be adsorbed to an interface of the alignment film to which no polymer adheres. For this reason, ghosting occurs occasionally.

The ghosting test is performed as follows. First, a pattern in which the central part of the display area is black and the peripheral part of the display area is white is displayed for a long time. Specifically, this pattern is displayed continuously, for example, in a high temperature tank of 70° C. for 240 hours. The backlight of the liquid crystal display device is kept turned on. Then, a prescribed intermediate level (gray scale level) is displayed in the entire display area. At this point, when it is found visually and by a luminance evaluation that the luminance of the peripheral part in which white has been displayed is different from the luminance of the central part in which black has been displayed, it is determined that ghosting has occurred. When the monomer concentration to the liquid crystal material is 0.20 wt. %, ghosting occurs; whereas when the monomer concentration is 0.22 wt. % or higher, ghosting does not occur.

In the impact test, it is checked whether or not the display quality of the liquid crystal panel is decreased after an impact is given to the liquid crystal display device. Even a liquid crystal panel which did not cause any alignment failure in the initial test may occasionally have the display quality decreased when given an impact. When the adhesiveness of the polymer to an interface of the alignment film is low because of the amount of the polymer formed and the growth speed of the polymer, the polymer is detached from the alignment film by the impact and the start point of the polymer which tilts the liquid crystal molecules is lost. In this case, the anchoring force of the polymer is partially decreased, and the pretilt angle of the liquid crystal molecules is changed. As a result, the alignment directions of the liquid crystal molecules are returned to the alignment direction before the polymer formation, i.e., the vertical alignment direction. The liquid crystal panel in which the pretilt angle has been changed in this manner appears to provide non-uniform display (stains). Accordingly, the adhesiveness of the polymer can be found based on the results of the impact test. Generally, the pretilt angle of the liquid crystal molecules is occasionally changed (in some cases, becomes zero) by aging. Accordingly, the results of the impact test also provide a barometer of aging.

The impact test is performed as follows. The liquid crystal panel is vibrated or an impact is given to a main surface of the liquid crystal panel, while the liquid crystal panel is operated, at a high temperature (e.g., 70° C.) and room temperature (e.g., 20° C.). Then, the display of the liquid crystal panel is checked visually and by a luminance evaluation. When the monomer concentration to the liquid crystal material is 0.20 wt. %, stains are generated by the impact; whereas when the monomer concentration is 0.22 wt. % or higher, no stain is generated.

From the above, it is understood that when the monomer concentration is decreased, the number of light spots is decreased; but when the monomer concentration is decreased excessively, ghosting, non-uniform display (stains) or the like is generated.

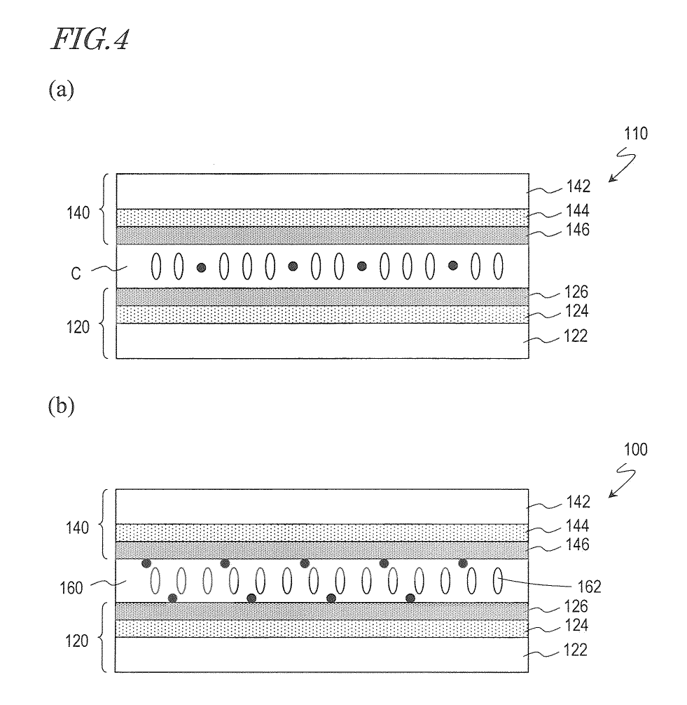

Hereinafter, with reference to FIG. 4, a method for producing the liquid crystal display device 100 will be described.

As shown in FIG. 4(a), a liquid crystal cell 110 is prepared. The liquid crystal cell 110 includes the rear substrate 120, the front substrate 140, and a mixture C interposed between the alignment film 126 of the rear substrate 120 and the alignment film 146 of the front substrate 140. The mixture C is formed of a liquid crystal material containing a liquid crystal compound and a photopolymerizable monomer mixed therein. The concentration of the photopolymerizable monomer to the liquid crystal material is 0.25 wt. %. The mixture C is sealed by a sealant (not shown in FIG. 4). The sealant is formed of a photocurable resin or a thermosetting resin, or formed of a resin having properties of both of a photocurable resin and a thermosetting resin.

The liquid crystal cell 110 is produced as follows, for example. One of the rear substrate 120 and the front substrate 140 is provided with a sealant in the shape of a frame enclosing a rectangle, and a liquid crystal material is dripped to an area enclosed by the sealant. Then, the rear substrate 120 and the front substrate 140 are brought together, and the sealant is cured. Such dripping of the liquid crystal material is also referred to as “one drop filling (ODF)” ODE makes it possible to provide the liquid crystal material uniformly, within a short time, and also at the same time to the entirety of a mother glass substrate. ODF also decreases the amount of the liquid crystal material which is disposed and so allows the liquid crystal material to be used efficiently. As described above, the liquid crystal material contains a liquid crystal compound and a photopolymerizable monomer mixed therein, and the concentration of the photopolymerizable monomer to the liquid crystal material is 0.25 wt. %.

Alternatively, the following process may be carried out. One of the rear substrate 120 and the front substrate 140 is provided with a sealant in the shape of a frame enclosing a rectangle which has an opening, and then the rear substrate 120 and the front substrate 140 are brought together to form a vacant cell. Then, the liquid crystal material is injected into a space between the rear substrate 120 and the front substrate 140. After this, the sealant is cured. As described above, the liquid crystal material contains a liquid crystal compound and a photopolymerizable monomer mixed therein, and the concentration of the photopolymerizable monomer is 0.25 wt. %.

Next, as shown in FIG. 4(b), in the state where a voltage is applied between the pixel electrode 124 and the counter electrode 144, the photopolymerizable monomer in the liquid crystal material is polymerized to form the alignment sustaining layer 130 on the alignment film 126 of the rear substrate 120 and also to form the alignment sustaining layer 150 on the alignment film 146 of the front substrate 140. When a voltage is applied between the pixel electrode 124 and the counter electrode 144, the liquid crystal molecules 162 are aligned in prescribed directions. By forming the polymer in this state, the liquid crystal molecules 162 in the vicinity of the alignment films are strongly regulated in this state. Therefore, even after the voltage is removed, the liquid crystal molecules 162 are kept inclined with respect to the direction normal to the main surfaces of the alignment films 126 and 146. The polymerization is performed by irradiating the liquid crystal layer with ultraviolet light at room temperature (e.g., 20° C.). In the case where a large amount of photopolymerizable monomer remains in the liquid crystal layer 160, the liquid crystal layer 160 may be irradiated with ultraviolet light for a while without applying a voltage between the pixel electrode 124 and the counter electrode 144, so that the concentration of the remaining photopolymerizable monomer is decreased. After this, driving circuits or polarizing plates are attached when necessary. The liquid crystal display device 100 is produced in this manner.

As described above, the liquid crystal cell 110 may be produced using ODF. In this case, the liquid crystal display device 100 is produced as follows.

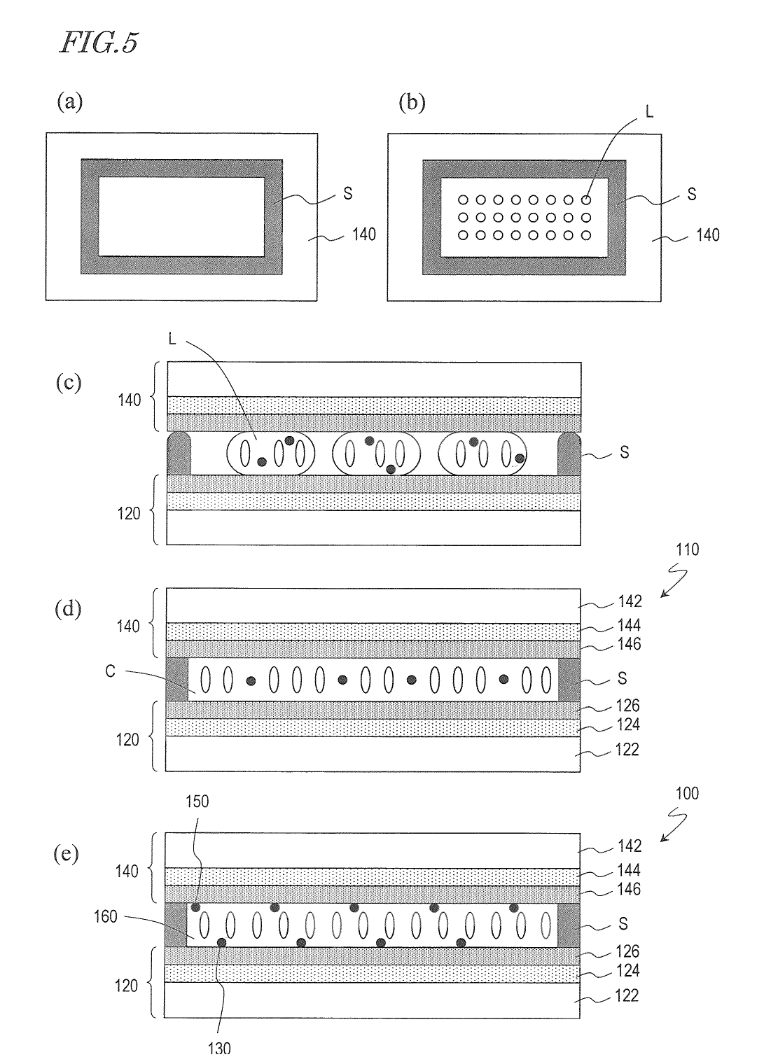

First, as shown in FIG. 5(a), for example, the front substrate 140 is provided with a sealant S for defining the liquid crystal area. The sealant S is formed of, for example, a photocurable resin or a thermosetting resin; specifically, an acrylic-based resin or an epoxy-based resin and a reactant thereto. Alternatively, the sealant S is formed of a photocurable resin, a thermosetting resin, or a resin having properties of a photocurable resin and a thermosetting resin and a reactant thereto.

Next, as shown in FIG. 5(b), a liquid crystal material L is dripped to the area enclosed by the sealant S. The liquid crystal material L contains a liquid crystal compound and a photopolymerizable monomer mixed therein.

Next, the rear substrate 120 is brought to the front substrate 140. FIG. 5(c) shows the rear substrate 120 and the front substrate 140 brought together. The process of bringing these substrate together is performed in a vacuum atmosphere. The substrates, after being brought together, are released to the atmospheric pressure. Then, the sealant S is irradiated with light to be cured. When necessary, the liquid crystal cell 110 may be further heated to cure the sealant S. When necessary, the liquid crystal cell 110 may be cut in order to draw terminals used to carry out the PSA technology.

In the above description, the liquid crystal material is dripped to the front substrate 140. The present invention is not limited to this. The liquid crystal material may be dripped to the rear substrate 120. For irradiating the sealant with light to cure the sealant, it is preferable to direct the light from the rear substrate 120 side because a black matrix is provided in the frame area of the front substrate in general. After the liquid crystal material is dripped to the front substrate 140, the liquid crystal cell 110 is produced by bringing the rear substrate 120 to the front substrate 140 and is moved onto a substrate stage having a light source thereabove. This way, the liquid crystal cell 110 is irradiated with light from the light source above the substrate stage. Thus, the light can be directed from the rear substrate 120 side. By dripping the liquid crystal material to the front substrate 140 in this manner, the liquid crystal panel can be produced by a simple process.

Next, as shown in FIG. 5(d), a voltage is applied between the pixel electrode 124 and the counter electrode 144, and the liquid crystal cell 110 is irradiated with ultraviolet light. The voltage is applied as follows. For example, a gate voltage of 10 V is kept applied to a gate line of the liquid crystal cell 110 to maintain a TFT of a corresponding pixel in an ON state, and a data voltage of 5 V is applied to all the source lines while a rectangular wave having an amplitude of 10 V (10 V at the maximum and 0 V at the minimum) is applied to the counter electrode 144. As a result, an AC voltage of ±5 V is applied between the pixel electrode 124 and the counter electrode 144. As can be seen, the voltage applied between the pixel electrode 124 and the counter electrode 144 is higher than the voltage applied in order to display the highest gray scale level in normal display of the liquid crystal display device. When a voltage is to be applied to the rear substrate 120, it is preferable to set the voltage applied to the gate line to be higher than the voltage applied to the source lines (i.e., the voltage of the pixel electrode 124). This way, the alignment disturbance of the liquid crystal molecules is reduced, and so a good display quality with less coarseness can be provided. By contrast, when the gate voltage is lower than the source voltage, the pixel floats (voltage is unstable).

Therefore, the alignment becomes unstable easily and the display is likely to appear to be coarse.

In the state where a voltage is thus applied, the liquid crystal cell 110 is irradiated with ultraviolet light (e.g., i-line at a wavelength of 365 nm; about 5.8 mW/cm²) for 3 to 5 minutes. As a result of this irradiation, the photopolymerizable monomer in the liquid crystal material is polymerized to form the polymer. As shown in FIG. 5(e), the alignment sustaining layers 130 and 150 are formed, and a pretilt angle of 0.1° to 5° is provided. In the case where the front substrate 140 includes a color filter layer, the intensity of the light reaching the liquid crystal layer through the front substrate 140 is varied in accordance with the color material of each color filter layer (e.g., red, green or blue), namely, the wavelength. Therefore, in order to provide a uniform pretilt angle, the liquid crystal cell 110 is generally irradiated with light directed from the rear substrate 120 side.

Next, in the state where no voltage is applied, the liquid crystal cell 110 is irradiated with, for example, ultraviolet light of about 1.4 mW/cm² for about 1 to 2 hours using black light. This decreases the concentration of the photopolymerizable monomer remaining in the liquid crystal layer. Such irradiation of light is also conducted from the rear substrate 120 side. As compared with the ultraviolet light used in the state where a voltage is applied, the ultraviolet light used in the state where no voltage is applied has a lower illuminance and is generally directed for a longer time. This series of steps described above is occasionally referred to as the “PSA processing”.

As can be seen, light irradiation performed in the absence of a voltage allows the photopolymerizable monomer remaining in the liquid crystal layer to be further adsorbed to the alignment sustaining layers 130 and 150 or to be further polymerized. As a result, the amount of the photopolymerizable monomer remaining in the liquid crystal layer can be further decreased. When the amount of the photopolymerizable monomer remaining in the liquid crystal layer is large, the photopolymerizable monomer molecules are polymerized slowly during the operation of the liquid crystal display device, which may undesirably cause ghosting. By performing light irradiation as described above, the occurrence of ghosting can be prevented. After this, polarizing plates or driving circuits are attached when necessary.

Alternatively, the voltage may be applied as follows while the liquid crystal cell is irradiated with ultraviolet light. A gate voltage of 15 V is kept applied to all the gate lines in the display area of the liquid crystal cell to maintain a TFT provided in each pixel in an ON state, and a data voltage of 0 V is applied to all the source lines while a rectangular wave having an amplitude of 10 V (5 V at the maximum and −5 V at the minimum) is applied to the counter electrode. As a result, an AC voltage of ±5 V is applied to the liquid crystal layer.

The alignment anchoring force or the pretilt angle can be controlled in accordance with the level of the voltage applied between the pixel electrode 124 and the counter electrode 144 and also the wavelength region or the irradiation time duration of the ultraviolet light. By increasing the voltage applied to the counter electrode 144 step by step, the disturbance of the alignment state in each pixel may be occasionally reduced to provide a good display quality with less coarseness.

As the light source, a low pressure mercury lamp (sterilizing lamp, fluorescent chemical lamp, black light), a high pressure discharge lamp (high pressure mercury lamp, metal halide lamp), a short arc discharge lamp (super-high pressure mercury lamp, xenon lamp, mercury xenon lamp) or the like may be used. Light from the light source may be directed to the liquid crystal cell as it is, or light of a particular wavelength (or of a particular wavelength region) selected by a filter may be directed.

### Embodiment 2

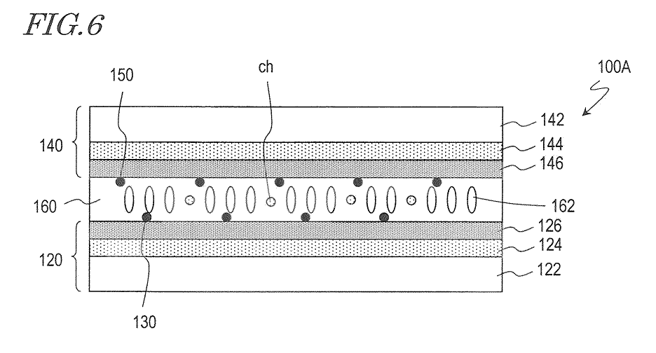

Hereinafter, with reference to FIG. 6, a liquid crystal display device in Embodiment 2 according to the present invention will be described. FIG. 6 shows a schematic view of a liquid crystal display device 100A in this embodiment. The liquid crystal display device 100A has substantially the same configuration as that of the liquid crystal display device 100 described above, except that a liquid crystal layer of the liquid crystal display device 100A contains a chiral agent. The descriptions of the identical elements to those of the liquid crystal display device 100 will be omitted to avoid redundancy.

The liquid crystal display device 100A includes a rear substrate 120, a front substrate 140, and a liquid crystal layer 160. The rear substrate 120 includes transparent insulating plate 122, pixel electrodes 124, and an alignment film 126. The front substrate 140 includes an insulating plate 142, a counter electrode 144, and an alignment film 146. In the liquid crystal display device 100A also, each pixel electrode 124 has a fishbone structure. The liquid crystal display device 100A may be of a CPA mode, and the pixel electrode 124 may include a unit electrode of a highly symmetrical shape (e.g., a generally square shape).

In the liquid crystal display device 100A in this embodiment, the liquid crystal layer 160 contains a chiral agent ch in addition to liquid crystal molecules 162. The liquid crystal material of the liquid crystal display device 100 described above contains a liquid crystal compound and a photopolymerizable compound, whereas the liquid crystal material of the liquid crystal display device 100A in this embodiment contains the chiral agent ch in addition to a liquid crystal compound and a photopolymerizable compound. The liquid crystal display device 100A is produced by substantially the same method as the liquid crystal display device 100 described above.

In the liquid crystal display device 100 described above, the pixel electrode 124 has a fishbone structure, and so extra liquid crystal domains may occasionally be formed on the trunk electrode 124j of the pixel electrode 124. In this case, dark lines are deformed as becoming thicker, or the alignment uniformity in each pixel is decreased. As a result, the display appears to be coarse or to have small light spots. By contrast, in the liquid crystal display device 100A, the pixel electrode 124 has a fishbone structure like in the liquid crystal display device 100 shown in FIG. 1, but the liquid crystal layer 160 contains the chiral agent ch and so the thickness of the dark lines is suppressed from increasing and the alignment uniformity in each pixel is stabilized. Therefore, when the liquid crystal display device 100A is of a CPA mode, the positions of the central axes of alignment are stabilized because the liquid crystal layer contains the chiral agent ch. Thus, the liquid crystal molecules are more easily aligned while being inclined in an axially symmetrical state, and the alignment uniformity in each pixel is also improved.

In the liquid crystal display device 100A, the amount of the chiral agent ch is determined as follows. By incorporation of the chiral agent ch, the liquid crystal molecules 162 obtain a helical structure. In this case, pitch (p) of the helical structure is determined based on selected reflected wavelength (λ) and refractive index (n) of the liquid crystal layer. Based on the pitch (p) and constant HTP (Helical Twisting Power=1/(c×p)) of the chiral agent, concentration (c) of the chiral agent is determined. Usually, the selected reflected wavelength is set to be outside the visible light region. Therefore, the concentration (c) of the chiral agent ch is in the range of 0.10 to 0.20 wt. % (preferably, 0.15 to 0.20 wt. %). As long as the concentration of the chiral agent ch is within the range of 0.10 to 0.20 wt. % as described above, the generation of the light spots can be suppressed also in the liquid crystal display device 100A.

In the liquid crystal display device 100A in this embodiment, the concentration of the photopolymerizable compound to the liquid crystal material is 0.22 wt. % or higher and 0.28. wt. % or less, and preferably is 0.25 wt. %. As the chiral agent ch, for example, US chiral (Merck & Co.) is used. The concentration of the chiral agent ch to the liquid crystal material is, for example, 0.16 wt. %. A chiral agent ch of an amount corresponding to the concentration of 0.16. wt. % is soluble in a liquid crystal compound.

By incorporating the chiral agent ch into the liquid crystal material, the alignment failure can be further suppressed. Hereinafter, with reference to Table 2, characteristics of liquid crystal panels having different monomer concentrations will be described. Table 2 shows the number of light spots per liquid crystal panel, and measurement results in an initial test, a ghosting test and an impact test when a photopolymerizable monomer of a concentration of 0.20 wt. % or 0.25 wt. % was incorporated together with a chiral agent. Table 2 also shows the number of light spots per liquid crystal panel, and measurement results in an initial test, a ghosting test and an impact test when a photopolymerizable monomer of a concentration of 0.25 wt. % or 0.3 wt. % was incorporated with no chiral agent. These measurements were performed in the same manner as described above with reference to Table 1. in Table 2, in the sections of the initial test, the ghosting test and the impact test, like in Table 1 described above, “X” indicates that most of the types of liquid crystal display devices did not fulfill the acceptability standard, and “◯” indicates that most of the types of liquid crystal display devices fulfilled the acceptability standard. “Δ” indicates that some of the types of liquid crystal display devices fulfilled the acceptability standard.

TABLE 2

| | Monomer concentration | | | |
|---|---|---|---|---|
| | 0.20 wt. % | 0.25 wt. % | 0.25 wt. % | 0.30 wt. % |
| Incorporation | Yes | NO | Yes | No |
| of chiral | (0.16 wt. %) | | (0.16 wt. %) | |
| No. of light | 0 | 0 | 0 | 20-30 |
| spots/panel | | | | |
| Initial test | X | ◯-Δ | ◯ | ◯ |
| Ghosting test | X | ◯ | ◯ | ◯ |
| Impact test | X | ◯ | ◯ | ◯ |

As can be understood from Table 2, when the monomer concentration to the liquid crystal material is 0.20 wt. % and 0.25 wt. %, no light spot is generated; whereas when the monomer concentration is 0.30 wt. % or higher, light spots are generated.

In the initial test, when the monomer concentration to the liquid crystal material is 0.25 wt. %, unless the chiral agent is incorporated, some of the types of the liquid crystal display devices do not fulfill the acceptability standard. By contrast, even when the monomer concentration to the liquid crystal material is 0.25 wt. %, if the chiral agent is incorporated, a majority of types of the liquid crystal display devices fulfill the acceptability standard.

In the ghosting test, when the monomer concentration to the liquid crystal material is 0.20 wt. %, ghosting occurs. By contrast, when the monomer concentration is 0.25 wt. % or higher, ghosting does not occur. The results of the ghosting test do not vary almost at all in accordance with whether the chiral agent is incorporated or not.

In the impact test, when the monomer concentration to the liquid crystal material is 0.20 wt. %, stains are generated. By contrast, when the monomer concentration is 0.25 wt. % or higher, no stain is generated. The results of the impact do not vary almost at all in accordance with whether the chiral agent is incorporated or not.

From the above, by incorporation of a chiral agent, the alignment failure of the liquid crystal panel can be suppressed without increasing the number of light spots.

With reference to Table 2, it has been described that when the concentration of the photopolymerizable monomer to the liquid crystal material is 0.25 wt. %, the generation of the light spots can be suppressed as well as the ghosting and the generation of stains. The concentration of the photopolymerizable monomer to the liquid crystal material is not limited to 0.25 wt. As long as the concentration of the photopolymerizable monomer is 0.22 wt. % or higher and 0.28 wt. % or less, the generation of the light spots can be suppressed as well as the ghosting and the generation of stains, like when the concentration is 0.25 wt. %.

In the above description, US chiral (Merck & Co.) is used as the chiral agent ch. The present invention is not limited to this. As the chiral agent ch, YS chiral (Merck & Co.), CN chiral, CB15 or the like may be used. Substantially the same effect can be provided by setting the concentration of the chiral agent to about 0.16 wt. %, regardless of the type thereof.

In the above description, the pixel electrode has a fishbone structure or includes a generally square unit electrode. The present invention is not limited to this. The pixel electrode may be flat with a generally rectangular shape, and the liquid crystal panel may be of any other VA mode, for example, the so-called MVA mode. Alternatively, the liquid crystal display device may be of an OCB (Optically Compensated Birefringence) mode or an ECS (Electrically Controlled Birefringence) mode. The liquid crystal panel may be of a TN mode.

The disclosure of Japanese Patent Applications Nos. 2009-43187 and 2009-139537, upon which the present application claims the benefit of priority, is incorporated herein by reference.

### INDUSTRIAL APPLICABILITY

According to the present invention, a liquid crystal display device in which the generation of light spots is suppressed can be provided.

### REFERENCE SIGNS LIST

100 Liquid crystal display device
110 Liquid crystal cell
120 Rear substrate
122 Insulating plate
124 Pixel electrode
126 Alignment film
130 Alignment sustaining layer
140 Front substrate
142 Insulating plate
144 Counter electrode
146 Alignment film
150 Alignment sustaining layer
160 Liquid crystal layer
162 Liquid crystal molecule

1. A method for producing a liquid crystal display device, comprising the steps of:
preparing a liquid crystal cell including a rear substrate having an alignment film, a front substrate having an alignment film, and a mixture interposed between the alignment film of the rear substrate and the alignment film of the front substrate, the mixture containing a liquid crystal compound and a photopolymerizable compound dissolved in the liquid crystal compound at a concentration of 0.22 wt. % or higher and 0.28 wt. % or less; and
polymerizing the photopolymerizable compound contained in the mixture of the liquid crystal cell to form alignment sustaining layers respectively on the alignment films of the rear substrate and the front substrate.

2. The method for producing a liquid crystal display device of claim 1, wherein the step of preparing the liquid crystal cell includes the step of bringing the rear substrate and the front substrate together using a photocurable resin or a thermosetting resin.

3. The method for producing a liquid crystal display device of claim 1, wherein in the step of preparing the liquid crystal cell, the mixture further contains a chiral agent.

4. A liquid crystal display device produced by the method of claim 1.
